(19) United States
(12) Patent Application Publication
(10) Pub. No.: US 2013/0110399 A1
(43) Pub. Date: May 2, 2013

(54) SYSTEM AND METHOD FOR PREDICTING AND PREVENTING FLOODING

(71) Applicant: Insurance Bureau of Canada, Toronto (CA)

(72) Inventors: Ian MOSS, Calgary (CA); Robert TREMBLAY, Toronto (CA)

(73) Assignee: INSURANCE BUREAU OF CANADA, Toronto (CA)

(21) Appl. No.: 13/665,341

(22) Filed: Oct. 31, 2012

Related U.S. Application Data
(60) Provisional application No. 61/553,525, filed on Oct. 31, 2011.

(51) Int. Cl. G01W 1/10; G06F 17/18

(52) U.S. Cl. CPC G01W 1/10; G06F 17/18
USPC 702/3

(57) ABSTRACT

A system and method for predicting and estimating risk of flooding in a geographical area of a municipality comprising determining a score representative of a risk of a flooding event to occur in the geographical area based on at least one climate variable and on an observation variable of the geographical area.

### CROSS-REFERENCE TO RELATED APPLICATION

This application claims priority to U.S. provisional patent application No. 61/553,525, filed on Oct. 31, 2011, the entirety of which is incorporated by reference in this application.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### TECHNICAL FIELD

The present invention relates to system and method related to predicting water damage resulting from flooding and surcharged urban drainage systems.

### BACKGROUND

Basement or sewage back-up flooding can cause large infrastructural damages. Under certain climatic conditions, such as heavy rains, some dwellings can become unfit due to flooding. In some cases, occupants have to be evacuated and extensive cleaning has to be performed before their return.

Flooding in urbanised areas can be the result of several factors. The density of urbanisation or the degree of deterioration of the infrastructure can influence the occurrence of flooding. Climate is also known to play a role in flooding. When heavy rainfalls or a warm day follows a snowy day, an unusual amount of water can flow in the municipal sewages. Past insurance claims from water damage to property is not a reliable risk indicator for future risk of a water damage or flooding event.

Municipalities wishing to renovate or adapt their infrastructure with the scope of decreasing risks of flooding seek for methods to evaluate flooding. The currently available methods are bottom-up based on determining the occurrence of flooding using detailed quantitative data and exact calculations. While these current methods provide acceptable results, they are expensive, computer intensive and are thus limited to relatively small geographical areas. Furthermore, they provide limited results in terms of determining future risks of flooding. Both insurers and municipalities need improved tools to better understand water damage risk.

Therefore, there is a need for a method for estimating future risk of flooding. There is also a need for a risk assessment tool which can provide a reliable failure risk of municipal storm/sanitary water infrastructure systems resulting in a water damage or flooding event.

### SUMMARY

It is an object of the present invention to ameliorate at least some of the inconveniences present in the prior art. It is another object to provide a system and method for predicting or preventing flooding caused by a climate event.

In one aspect, the present invention provides a system for evaluating infrastructure vulnerability to be at least considered for upgrade repaired in a plurality of geographical areas of a municipality. The system comprises a first computer readable storage medium having a database. A computer processor is in electronic communication with the database on the first computer readable storage medium. The computer processor is in electronic communication with a software program stored on a second computer readable storable medium. The software program includes instructions that when executed by the computer processor: retrieve from the database at least one observation associated with each of the plurality of geographical areas. The at least one observation includes at least one set of values associated with at least some of a plurality of variables recorded within at least one period of time, and a flooding event associated with the at least one set of values recorded within the at least one period of time. The plurality of variables influence flooding within the plurality of geographical areas. At least some of the plurality of variables are related to at least one of a combined sewer density, an average age of combined sewer, a hydrodynamic slope diameter low risk rating. The plurality of variables is common to the plurality of geographical areas. The software program includes instructions that when executed by the computer processor retrieve from the database at least one value of at least one climate variable. The at least one climate variable is common to the plurality of geographical areas. The software program includes instructions that when executed by the computer processor cause the computer processor to determine for at least some of the plurality of geographical areas a score representative of the risk of the flooding event to occur based on the at least one climate variable and on the plurality of variables. The score is at least in part determined using the plurality of observations and the at least one value of the at least one climate variable. The software program includes instructions that when executed by the computer processor cause the computer processor to indicate that at least one infrastructure component in at least one geographical area should be at least repaired, when the score in at least one the geographical area is indicative of a risk of flooding.

In a further aspect, a display is in electronic communication with the computer processor. The software program further includes instructions that when executed by the computer processor: display a map on the display. The map is displaying the scores associated with the at least some of the plurality of geographical areas.

In another aspect a computer-implemented method of evaluating infrastructure to be at least repaired in a plurality of geographical areas of a municipality comprises providing at least one observation associated with each of the plurality of geographical areas. The at least one observation includes: at least one set of values associated with at least some of a plurality of variables recorded within at least one period of time, and a flooding event associated with the at least one set of values recorded within the at least one period of time. The plurality of variables influence flooding within the plurality of geographical areas. At least some of the plurality of variables are related to at least one of a combined sewer density, an average age of combined sewer, a hydrodynamic slope diameter low risk rating. The plurality of variables is common to the plurality of geographical areas. The method comprises providing for each of the plurality of geographical areas an associated at least one value of at least one climate variable. The at least one climate variable is common to the plurality of geographical areas. The method comprises determining for at least some of the plurality of geographical areas a score representative of the risk of the flooding event to occur based on the at least one climate variable and on the plurality of variables. The score is at least in part determined using the plurality of observations and the at least one value of the at least one climate variable. The method comprises indicating that at least one infrastructure component in at least one geographical area should be at least repaired, when the score in at least one the geographical area is indicative of a risk of flooding.

In a further aspect, the method comprises displaying the scores associated with the at least some of the plurality of geographical areas on a map.

In an additional aspect, at least one of the at least one set of values associated with the plurality of variables and the at least one value of the at least one climate variable is a value estimated for a period of time posterior to the at least one period of time.

In yet another aspect, a method of evaluating infrastructure to be at least repaired in a plurality of geographical areas of a municipality comprises providing for each of the plurality of geographical areas at least one observation, the at least one observation including: at least one set of values associated with at least some of the plurality of variables recorded within at least one period of time, and a flooding event associated with the at least one set of values recorded within the at least one period of time. The plurality of variables influence flooding within the plurality of geographical areas. At least some of the plurality of variables is related to at least one of a combined sewer density, an average age of combined sewer, a hydrodynamic slope diameter low risk rating. The plurality of variables is common to the plurality of geographical areas. The method comprises providing for each of the plurality of geographical areas an associated at least one value of at least one climate variable. The at least one climate variable is common to the plurality of geographical areas. The method comprises obtaining for at least some of the pluralities of geographical areas a score representative of the risk of the flooding event to occur based on the at least one climate variable and on the plurality of variables. The score is at least in part determined using the plurality of observations and the at least one value of the at least one climate variable. The method comprises indicating that at least one infrastructure component in at least one geographical area should be at least repaired, when the score in at least one the geographical area is indicative of a risk of flooding.

In a further aspect, the method comprises displaying the score associated with the at least some of the plurality of geographical areas on a map.

In an additional aspect, the method comprises determining the risk of the flooding to occur in the at least some of the plurality of geographical areas by comparing the score of the at least some of the plurality of geographical areas relative to at least one predetermined threshold common to the plurality of geographical areas.

In a further aspect, the at least one predetermined threshold includes first and second thresholds, the first threshold discriminating between scores representing a high risk of the flooding event to occur and scores representing a medium risk of the flooding event to occur, and the second threshold discriminating between scores representing the medium risk of the flooding event to occur and scores representing a low risk of the flooding event to occur.

In an additional aspect, the method is a method of estimating the risk of the flooding event to occur at a time posterior to the at least one period of time. At least one of the plurality of variables and the at least one climate variable is associated with a time dependent name. Providing the at least one observation and the at least one value of the at least one climate variable for each of the plurality of geographical areas includes calculating the time dependent value of the at least one of the plurality of variables and the at least one climate variable at the time posterior to the at least one period of time. Obtaining the score representative of the risk of the flooding event to occur includes obtaining for the at least some of the plurality of geographical areas a score representative of the risk of the flooding event to occur at the time posterior to the at least one period of time based on the at least one climate variable and the plurality of variables. The score is at least in part determined by using the plurality of the observations, the at least one value of the at least one climate variable and the time dependent value of the at least one of the plurality of variables and the at least one climate variable.

In a further aspect, the at least one climate variable is related to a rain fall index.

In an additional aspect, the at least one climate variable is one of the plurality of variables and the at least one observation associated with each geographical area includes the at least one value of the at least one climate variable.

In a further aspect, the flooding event is a categorical event.

In an additional aspect, for each of the plurality of geographical areas: the flooding event has a first associated value when at least one flooding event has occurred, and the flooding event has a second associated value when no flooding event has occurred.

In a further aspect, a value associated with the flooding event of the plurality of geographical areas is empirical.

In an additional aspect, the score is calculated using a linear combination of the pluralities of variables obtained by a linear regression.

In a further aspect, at least some of the plurality of variables are related to infrastructure.

In an additional aspect, obtaining for the at least some of the plurality of geographical areas the score representative of the risk of the flooding event to occur includes: determining a function of the plurality of variables, transforming the function into a probability distribution, transforming the probability distribution into a score function where the score function depends on the at least one climate variable, and calculating for the at least some of the plurality of geographical areas the score by inputting into the score function the at least one set of values associated with the plurality of variables and the at least one value of the at least one climate variable.

In a further aspect, the method includes determining the risk of the flooding event to occur for the at least some of the plurality of geographical areas by comparing the probability distribution of each of the at least some of the plurality of geographical areas to at least one predetermined probability threshold. The at least one predetermined threshold is common to the plurality of the geographical areas.

In an additional aspect, transforming the function into a probability distribution includes using a log odd function.

In a further aspect, the plurality of variables is a first plurality of variables. Obtaining for the at least some of the geographical areas the score representative of the risk of the flooding event to occur includes: selecting a second plurality of variables from the first plurality of variables. The second plurality of variables is smaller than the first plurality of variables. The second plurality of variables most influence flooding relative to variables of the first plurality not belonging to the second plurality. The score of the at least some of the plurality of geographical areas is based on the at least one climate variable and the second plurality of variables, and is at least in part determined using the plurality of observations and the at least one value of the at least one climate variable.

In an additional aspect, the flooding event is a categorical event. Obtaining the score representative of the risk of the flooding event to occur and selecting the second plurality of variables from the first plurality of variables includes performing at least one of a forward discriminant analysis, a backward discriminant analysis and a stepwise discriminant analysis.

In yet another aspect, a system for estimating a risk of a flooding event to occur in a plurality of geographical areas comprises a first computer readable storage medium having a database. A computer processor is in electronic communication with the database on the first computer readable storage medium. The computer processor is in electronic communication with a software program stored on a second computer readable storable medium. The software program includes instructions that when executed by the computer processor: retrieve from the database at least one observation associated with each of the plurality of geographical areas, the at least one observation including: at least one set of values associated with at least some of a plurality of variables recorded within at least one period of time, and a flooding event associated with the at least one set of values recorded within the at least one period of time, the plurality of variables influencing flooding within the plurality of geographical areas. At least some of the plurality of variables is related to at least one of a combined sewer density, an average age of combined sewer, a hydrodynamic slope diameter low risk rating. The plurality of variables is common to the plurality of geographical areas. The instructions when executed by the computer processor include retrieve from the database at least one value of at least one climate variable. The at least one climate variable is common to the plurality of geographical areas. The instructions when executed by the computer processor include cause the computer processor to determine for at least some of the plurality of geographical areas a score representative of the risk of the flooding event to occur based on the at least one climate variable and on the plurality of variables. The score is at least in part determined using the plurality of observations and the at least one value of the at least one climate variable.

In a further aspect, the instructions when executed by the computer processor cause the computer processor to communicate with the database to store the scores in the database.

In an additional aspect, a display is in electronic communication with the computer processor. The software program further includes instructions that when executed by the computer processor: display a map on the display, the map displaying the scores associated with the at least some of the plurality of geographical areas.

In yet another aspect, a computer-implemented method of estimating a risk of a flooding event to occur in a plurality of geographical areas comprises providing at least one observation associated with each of the plurality of geographical areas. The at least one observation includes: at least one set of values associated with at least some of a plurality of variables recorded within at least one period of time, and a flooding event associated with the at least one set of values recorded within the at least one period of time. The plurality of variables influence flooding within the plurality of geographical areas. At least some of the plurality of variables is related to at least one of a combined sewer density, an average age of combined sewer, a hydrodynamic slope diameter low risk rating. The plurality of variables is common to the plurality of geographical areas. The method includes providing for each of the plurality of geographical areas an associated at least one value of at least one climate variable. The at least one climate variable is common to the plurality of geographical areas. The method includes determining for at least some of the plurality of geographical areas a score representative of the risk of the flooding event to occur based on the at least one climate variable and on the plurality of variables. The score is at least in part determined using the plurality of observations and the at least one value of the at least one climate variable.

In a further aspect, the method includes storing the scores. In an additional aspect, the method includes displaying the scores associated with the at least some of the plurality of geographical areas on a map.

In a further aspect, at least one of the at least one set of values associated with the plurality of variables and the at least one value of the at least one climate variable is a value estimated for a period of time posterior to the at least one period of time.

In yet another aspect, there is provided a method of estimating a risk of a flooding event to occur in a plurality of geographical areas comprises providing for each of the plurality of geographical areas at least one observation. The at least one observation includes: at least one set of values associated with at least some of the plurality of variables recorded within at least one period of time, and a flooding event associated with the at least one set of values recorded within the at least one period of time. The plurality of variables influence flooding within the plurality of geographical areas. At least some of the plurality of variables are related to at least one of a combined sewer density, an average age of combined sewer, a hydrodynamic slope diameter low risk rating. The plurality of variables is common to the plurality of geographical areas. The method includes providing for each of the plurality of geographical areas an associated at least one value of at least one climate variable. The at least one climate variable is common to the plurality of geographical areas. The method includes obtaining for at least some of the pluralities of geographical areas a score representative of the risk of the flooding event to occur based on the at least one climate variable and on the plurality of variables. The score is at least in part determined using the plurality of observations and the at least one value of the at least one climate variable.

In a further aspect, the method includes storing the scores. In an additional aspect, the method includes displaying the score associated with the at least some of the plurality of geographical areas on a map. In a further aspect, the plurality of geographical areas are subdivisions of a municipality. The method further comprises changing at least one infrastructure component in at least one geographical area in order to decrease the risk of the flooding event to occur in the at least one geographical area, when the score in at least one the geographical area is indicative of a risk of flooding.

In an additional aspect, the method includes determining the risk of the flooding to occur in the at least some of the plurality of geographical areas by comparing the score of the at least some of the plurality of geographical areas relative to at least one predetermined threshold common to the plurality of geographical areas.

In a further aspect, the at least one predetermined threshold includes first and second thresholds. The first threshold discriminates between scores representing a high risk of the flooding event to occur and scores representing a medium risk of the flooding event to occur. The second threshold discriminates between scores representing the medium risk of the flooding event to occur and scores representing a low risk of the flooding event to occur.

In an additional aspect, the method is a method of estimating the risk of the flooding event to occur at a time posterior to the at least one period of time. At least one of the plurality of variables and the at least one climate variable is associated with a time dependent name. Providing the at least one observation and the at least one value of the at least one climate variable for each of the plurality of geographical areas includes: calculating the time dependent value of the at least one of the plurality of variables and the at least one climate variable at the time posterior to the at least one period of time. Obtaining the score representative of the risk of the flooding event to occur includes: obtaining for the at least some of the plurality of geographical areas a score representative of the risk of the flooding event to occur at the time posterior to the at least one period of time based on the at least one climate variable and the plurality of variables. The score is at least in part determined by using the plurality of the observations, the at least one value of the at least one climate variable and the time dependent value of the at least one of the plurality of variables and the at least one climate variable.

In a further aspect, the at least one climate variable is related to a rain fall index. In an additional aspect, in the at least one climate variable is one of the plurality of variables and the at least one observation associated with each geographical area includes the at least one value of the at least one climate variable.

In a further aspect, the flooding event is a categorical event. In an additional aspect, for each of the plurality of geographical areas: the flooding event has a first associated value when at least one flooding event has occurred, and the flooding event has a second associated value when no flooding event has occurred.

In a further aspect, a value associated with the flooding event of the plurality of geographical areas is empirical. In an additional aspect, the score is calculated using a linear combination of the pluralities of variables obtained by a linear regression. In a further aspect, at least some of the plurality of variables are related to infrastructure.

In an additional aspect, obtaining for the at least some of the plurality of geographical areas the score representative of the risk of the flooding event to occur includes: determining a function of the plurality of variables, transforming the function into a probability distribution, transforming the probability distribution into a score function where the score function depends on the at least one climate variable, and calculating for the at least some of the plurality of geographical areas the score by inputting into the score function the at least one set of values associated with the plurality of variables and the at least one value of the at least one climate variable.

In a further aspect, the method further comprises determining the risk of the flooding event to occur for the at least some of the plurality of geographical areas by comparing the probability distribution of each of the at least some of the plurality of geographical areas to at least one predetermined probability threshold. The at least one predetermined threshold is common to the plurality of the geographical areas. In an additional aspect, the method includes transforming the function into a probability distribution includes using a log odd function.

In a further aspect, the plurality of variables is a first plurality of variables. Obtaining for the at least some of the geographical areas the score representative of the risk of the flooding event to occur includes: selecting a second plurality of variables from the first plurality of variables. The second plurality of variables is smaller than the first plurality of variables. The second plurality of variables most influence flooding relative to variables of the first plurality not belonging to the second plurality. The score of the at least some of the plurality of geographical areas is based on the at least one climate variable and the second plurality of variables, and is at least in part determined using the plurality of observations and the at least one value of the at least one climate variable.

In an additional aspect, the flooding event is a categorical event. Obtaining the score representative of the risk of the flooding event to occur and selecting the second plurality of variables from the first plurality of variables includes performing at least one of a forward discriminant analysis, a backward discriminant analysis and a stepwise discriminant analysis.

In another aspect, there is provided a method of estimating risk of a future water damage event in at least one geographical area, the method comprising: selecting at least one observation variable, the at least one observation variable having at least one set of values recorded for the at least one geographical area over a period of time that includes a past water damage event, the at least one observation variable influencing flooding in the at least one geographical area; selecting at least one climate variable, the at least one climate variable having at least one value for the at least one geographical area, the at least one climate variable influencing the water damage event in the at least one geographical area; and determining for the at least one geographical area a flood risk score representative of the risk of the future water damage event to occur based on the at least one observation variable and the at least one climate variable.

In one embodiment, the method is carried out in a plurality of geographical areas in a municipality. In another embodiment, the at least one observation variable is selected from a combined sewer density, an average age of a combined sewer, a hydrodynamic slope, a building count, a building area, a land use, a soil type, a soil permeability, a vegetation cover, a slope, and a tree cover terrain slope. In another embodiment, more than one observation variable is selected. In another embodiment, the at least one climate variable is obtained from an intensity, duration and frequency of precipitation in the at least one geographical area.

In another embodiment, determining the flood risk score comprises: determining a function of the plurality of variables; transforming the function into a probability distribution; transforming the probability distribution into a score function wherein the score function depends on the at least one climate variable; and determining the flood risk score by inputting into the score function at least one value of the at least one structural variable and at least one value of the at least one climate variable. In another embodiment, transforming the function into a probability distribution includes using a log odd function.

In another embodiment, the water damage event is a categorical event, and determining the flood risk score further comprises: performing at least one of a forward discriminant analysis, a backward discriminant analysis and a stepwise discriminant analysis.

In another embodiment, determining the flood risk score further comprises: comparing the probability distribution of the at least one geographical area to at least one predetermined probability threshold. In another embodiment, the method further comprises displaying the flood risk score associated with at least one geographical area on a map.

In another aspect, there is provided a method of mitigating a future water damage event in at least one geographical area, the method comprising: selecting at least one observation variable, the at least one observation variable having at least one set of values recorded for the at least one geographical area over a period of time that includes a past water damage event, the at least one observation variable influencing water damage in the at least one geographical area; selecting at least one climate variable, the at least one climate variable having at least one value for the at least one geographical area, the at least one climate variable influencing water damage in the at least one geographical area; determining for the at least one geographical area a flood risk score representative of the risk of a future water damage event to occur based on the at least one observation variable and the at least one climate variable; and indicating at least one infrastructure component in the at least one geographical area to be at least repaired to reduce the flood risk score in the at least one geographical area.

In one embodiment, the method is carried out in a plurality of geographical areas in a municipality. In another embodiment, the at least one infrastructure component is a sewer system.

In another embodiment, the at least one observation variable is selected from a combined sewer density, an average age of a combined sewer, a hydrodynamic slope, a building count, a building area, a land use, a soil type, a soil permeability, a vegetation cover, a slope, and a tree cover terrain slope. In another embodiment, more than one observation variable is selected. In another embodiment, the at least one climate variable is obtained from an intensity, duration and frequency of precipitation in the at least one geographical area.

In another embodiment, determining the flood risk score comprises: determining a function of the at least one observation variable; transforming the function into a probability distribution; transforming the probability distribution into a score function wherein the score function depends on the at least one climate variable; and determining the flood risk score by inputting into the score function at least one value of the at least one observation variable and at least one value of the at least one climate variable. In another embodiment, transforming the function into a probability distribution includes using a log odd function.

In another embodiment, the future flooding event is a categorical event, and wherein determining the flood risk score further comprises: performing at least one of a forward discriminant analysis, a backward discriminant analysis and a stepwise discriminant analysis.

In another embodiment, determining the flood risk score further comprises: comparing the probability distribution of the geographical area to at least one predetermined probability threshold. In another embodiment, the method further comprises displaying the flood risk score associated with the at least one geographical area on a map.

In another aspect, there is provided a computer-implemented system for estimating or mitigating a future water damage event in at least one geographical area, the system comprising: a database; and a computer processor in electronic communication with the database, the computer processor in electronic communication with a software program, the software program including instructions that when executed by the computer processor: selects at least one observation variable, the at least one observation variable having at least one set of values recorded for the at least one geographical area over a period of time that includes a past water damage event, the at least one observation variable influencing flooding in the at least one geographical area; selects from the database at least one climate variable, the at least one climate variable having at least one value for the geographical area, the at least one climate variable influencing flooding in the at least one geographical area; and determines for the at least one geographical area a flood risk score representative of the risk of a future water damage event to occur based on the at least one observation variable and the at least one climate variable.

In another embodiment, determining the flood risk score comprises: determining a function of the plurality of variables; transforming the function into a probability distribution; transforming the probability distribution into a score function wherein the score function depends on the at least one climate variable; and determining the flood risk score by inputting into the score function at least one value of the at least one structural variable and at least one value of the at least one climate related variable. In another embodiment, transforming the function into a probability distribution includes using a log odd function.

In another embodiment, the future flooding event is a categorical event, and wherein determining the flood risk score further comprises: performing at least one of a forward discriminant analysis, a backward discriminant analysis and a stepwise discriminant analysis.

In another embodiment, determining the flood risk score further comprises: comparing the probability distribution of the geographical area to at least one predetermined probability threshold. In another embodiment, the method further comprises displaying the flood risk score associated with the at least one geographical area on a map.

In another embodiment, the electronic communication between the database and the computer processor is internet, intranet, or cloud computing.

Embodiments of the present invention each have at least one of the above-mentioned objects and/or aspects, but do not necessarily have all of them. It should be understood that some aspects of the present invention that have resulted from attempting to attain the above-mentioned objects may not satisfy these objects and/or may satisfy other objects not specifically recited herein.

Additional and/or alternative features, aspects, and advantages of embodiments of the present invention will become apparent from the following description, the accompanying drawings, and the appended claims.

### BRIEF DESCRIPTION OF THE DRAWINGS

For a better understanding of the present invention, as well as other aspects and further features thereof, reference is made to the following description which is to be used in conjunction with the accompanying drawings, where:

FIG. 1 is a schematic of an architecture providing a flooding risk assessment system;

FIG. 2 is a flow chart representing the flooding risk assessment system;

FIG. 3A is a top plan view of a municipality, and FIG. 3B is a close-up view of FIG. 3A showing a plurality of geographical areas;

FIG. 4 illustrates an intensity duration and frequency table;

FIG. 5 is a flow chart illustrating a first embodiment of a method of estimating a risk of a flooding event to occur;

FIG. 6 is a close-up view of a map displaying different risks of the flooding events to occur based on the method of FIG. 5 and using different shadings;

FIG. 7 is a flow chart illustrating a second embodiment of a method of estimating a risk of a flooding event to occur;

FIG. 8 illustrates a table used for the method of FIG. 7;

FIG. 9 is a flow chart illustrating a risk assessment conceptual framework;

FIG. 10 is a graph of an updated intensity, duration, frequency (IDF) curve for the city of Hamilton, Ontario;

FIG. 11 is a schematic of a database as used in the present system; and

FIGS. 12A and 12B illustrates a geographical map of a predicted water damage risk for a plurality of geographical areas in a municipality for a low rain scenario (12A) and a high rain scenario (12B).

### DETAILED DESCRIPTION

As used herein, the term “water damage event” is used to refer to an event caused by a combination of precipitation and/or geographical variables that can result in water damage to a property, building or infrastructure. Some non-limiting examples of water damage events can occur as a sewer backup event, surcharged urban drainage system, urban flooding, and overland flooding. The term “flooding event” is used to refer to a particular type of water damage event, where “flooding,” as used herein, is understood to be a general term referring to an excess of water caused by a combination of precipitation, geographical and/or climate variables that result in a water damage event. As will be described in more detail below, the mechanism by which a water damage event can occur can involve multiple factors, including but not limited to the intensity, duration and frequency of precipitation, geographical features of the geographical area such as elevation and type of soil, and type and age of infrastructure. The terms “flood risk” and “water damage risk” are used interchangeably. It should be noted that, although the description that follows describes specific embodiments that relate to determining risk of a flooding event, this application is directed to methods and systems for estimating risk of future water damage events more generally. The estimation of risk of a future flooding event is provided as an exemplary embodiment only.

As used herein, the terms “climate related variable” and “climate variable” are used interchangeably.

The presently described system and method can assist property and casualty insurers in evaluating the risk of failures in the performance of municipal sewer systems, including but not limited to sanitary and storm sewers, that may result in backups or backflows causing insured property damage losses. The presently described system and method can also assist municipalities in prioritizing maintenance to infrastructure systems to mitigate risk of a water damage event caused in part by a climatic event.

The present system and method combines, among other variables, hydrology data, climate forecasting data, information concerning the age and performance of municipal sewer infrastructure and insurance claims history information to determine a water damage or flood risk score for certain areas within a municipality. This water damage or flood risk score can also be used by municipalities to alert them to high risk of water damage risk in a geographical area such that infrastructural improvements can be indicated to reduce the risk of a water damage event.

Some conditions, known as vulnerability indicators, that reflect the sensitivity of a particular geographic area to a climatic event include hydraulic slope of the geographic area, land use, and parcel count. Some conditions, known as exposure indicators, can influence the severity of a climatic event include land use, terrain, and proximity to water. These conditions can be further specified by particular observation variable for each geographical area under investigation.

Further, there are variety of mitigation indicators, which are conditions within a geographical area which can reduce impact of exposure and vulnerability of that area to a climatic event. These mitigation indicators are most often related to the presence and condition of infrastructure in the geographical area. Some mitigation indicators include the infrastructure operation & maintenance, emergency planning, and level of service in the geographical area.

The climate is changing, and by combining the indicators, geographical areas at risk of water damage can be identified, along with the level of future risk based on the observation variables in the geographic area. In this way, insurers as well as municipalities can gauge the level of water damage risk for a geographical area. With this knowledge, appropriate steps can be taken to inform others of the risk, as well as possibly mitigate the risk by identifying infrastructure to be repaired. Availability of insurance, updated rainfall climatic information and information on the impact of future climate variables can assist municipalities at prioritizing infrastructure investments.

The present system can be operated through a web portal, such as internet or intranet, a cloud computing system, or any other electronic communication method that can be used to access data from a database via a computer processor. A geographic information system (GIS) risk map can also be generated for a municipality, and a working section of the section can be provided which will allow municipalities to see the impact of certain infrastructure projects on the water damage risk score in any given geographic area.

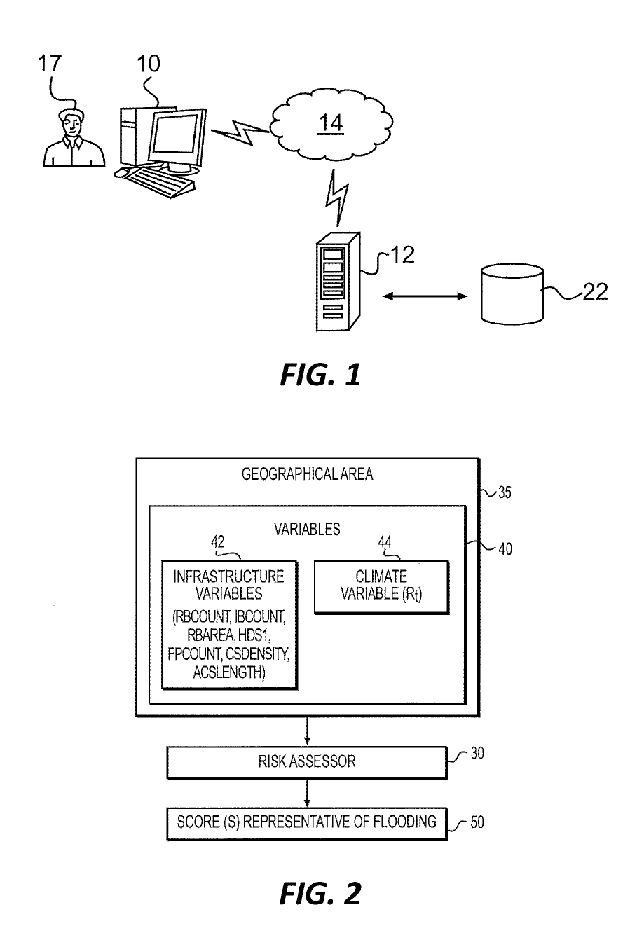

FIG. 1 illustrates an embodiment of an architecture providing a flooding risk assessment system. The flooding risk assessment system described herein relies on Internet-based services using software as service model. It is contemplated that the flooding risk assessment system could rely on other business models, such as software distribution. The software could be contained in a DVD or a CD-Rom or could be downloadable from the Internet. The software could also be used in connection with Internet-based services.

One example of an architecture of the present water damage risk system comprises a computing entity referred herein as a server 12 connected to a data network 14 or database. The server or computer processor 12 implements a data network site accessible (i.e. website) via the data network 14 (i.e. Internet). The web site hosts a flooding risk assessor 30. Although shown as being one element, the server 12 may be implemented by one or more computers (e.g. a server farm or other group of networked computers) forming a computing entity. The server 12 can be implemented by using various software technologies, which will not be described herein. It is contemplated that at least some information is saved locally in a client computer 10. The server 12 is in communication with a database 22. It is contemplated that the server 12 could be in communication with multiple databases. It is also contemplated that the database could be remotely located from the computer processor.

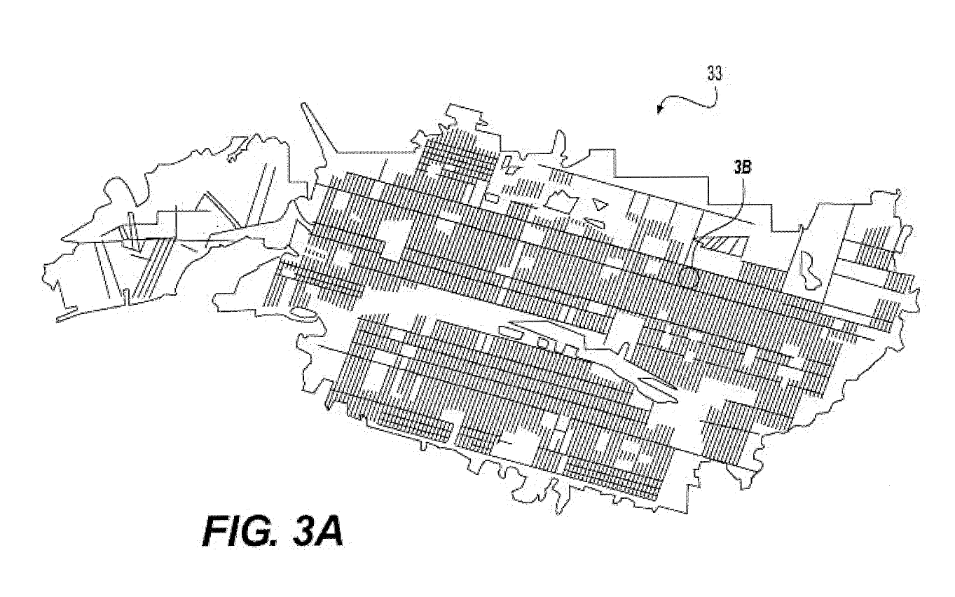

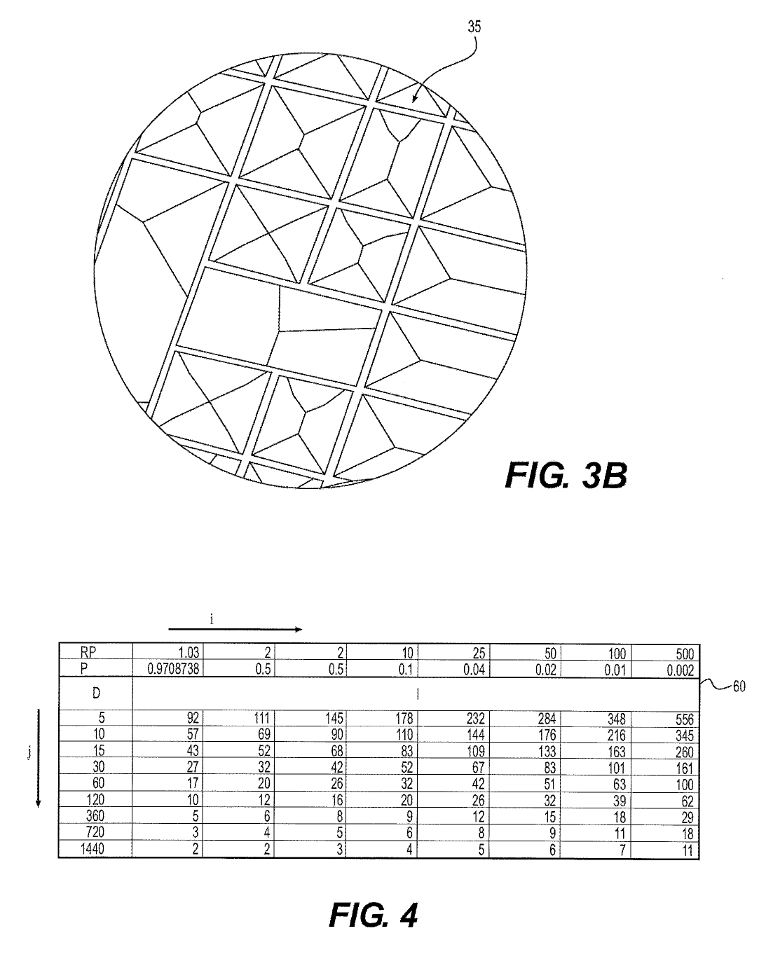

A user 17 can use a client computer 10 to interact with the server 12 or computer processor over the data network 14. The user 17 can be an employee of municipality 33 (shown in FIG. 3A). It is contemplated that only more than one user could be interacting simultaneously or at different times with the server 12. Two users interacting with the flooding risk assessment system could belong to two different municipalities. They would each access different data sets, each data sets corresponding to one of municipalities. It is contemplated that the user 17 is not an employee of the municipality 33. For example, the user 17 could be an insurance employee performing risk assessment in order to price their insurance policies. In another example, the user 17 is a student of a university working on a project or doing research related to flooding.

The client computer 10 is a computing entity and optionally has a display and/or a keyboard. The computing entity or computer processor may be implemented by a combination of hardware and software. It is contemplated that the client computer 10 could have one or more output devices. It is also contemplated that the client computer 10 could have one or more input devices such as a mouse, a microphone, a stylus, a camera and/or a touch screen. It is also contemplated that the client computer 10 could be a portable device and that the electronic communication to the computer processor database could be wireless. The present computer-implemented system can therefore be operated by a user remotely through a web portal or a cloud computing system.

The database can be housed on the internet or in a cloud computing platform which is accessible to the computer processor by way of the electronic communication. The computer processor can be the client computer, or can be accessed by the client computer over the internet or in a cloud computing platform.

In operation, a user 17 can use the client computer 10 to access the website or cloud computing system implemented by the server 12. Access to the website requires the user 17 to log on to the website by providing identification information (e.g., a special code or personal information such as, for example, his/her name, date of birth, email address) and authentication information (e.g. a password). It is contemplated that access to the website could be direct (i.e. without requiring any log-on procedure from the user 17). Once logged on the website, the user 17 can use the flooding risk assessor 30 to estimate a risk of flooding for some or all of the municipality 33 territory, as will be described below. The database can also be remote from the computer processor. In addition, the software program can be located on the computer processor, or can be located on a secondary computer processor

Turning now to FIGS. 2 to 6, an embodiment of the flooding risk system will be described. Referring to FIG. 2, the flooding risk assessor 30 is a tool to estimate by probabilistic means a risk of a flooding event to occur in one or more of the geographical areas 35. The type of flooding considered by the risk assessor 30 can be, for example, basement or sewage flooding. It is contemplated that only basement or only sewage flooding could be considered. It is also contemplated that other types of flooding could be considered. A plurality of observation variables 42, 44 and event (referred as 39 in FIG. 2) is inputted to the flooding risk assessor 30 and a score 50 representative of the risk of the flooding event to occur in one or more geographical areas 35 is outputted by the risk assessor 30. Methods 100, 100′ of assessing the risk of the flooding event to occur will be described below.

As shown in FIGS. 3A and 3B, the geographical areas 35 are subdivisions of the territory of the municipality 33. The geographical areas 35 form a plurality of contiguous polygons. Each of the geographical areas 35 can be, for example, the smallest of a post local delivery unit and a 200 m by 200 m grid where a post local delivery unit is nonexistent. The postal delivery unit and 200 m×200 m grid are specified by the user 17. The 200 m by 200 m grid allows for risk analysis in those areas of the municipality 33 that do not have post local delivery unit to be taken into account by the flooding risk assessor 30. For example, parks with no postal delivery are not post local delivery units and are subdivided by the 200 m by 200 m grid. A single geographical area 35 cannot belong to two postal codes. The geographical areas 35 together form a homogeneous layer that covers an entire area inside the municipality 33's civic boundary. It is contemplated that the geographical areas 35 could be defined differently. For example, the geographical areas 35 could comprise only post local delivery units. In another example, one could first identify those areas where the geographic pattern of flooding has occurred. The geographical pattern would show geographical areas of flooding concentration and geographical areas of dispersed recorded flooding. The shape and size of the geographical areas could be based on the geographic pattern. It is contemplated that the geographical areas 35 could not be specified by the user 17, but could be predetermined or defined by a user other than the user 17. It is contemplated that the grid could have dimensions bigger or smaller than 200 m by 200 m. It is also contemplated that the grid could be formed of a rectangular grid. It is also contemplated that the user could define some or all of the geographic areas 35 on an individual basis. The user 17 could determine the different polygons by, for example, drawing the boundaries of the polygons on a map of the municipality 33.

The plurality of variables 40 inputted to the risk assessor 30 includes a climate related variable (Rₜ) (referred to in FIG. 2 as 44) and a plurality of observation variables 42. When the method is used for a plurality of geographical areas, the plurality of variables 40 is common to the plurality of geographical areas 35.

The climate related variable Rₜ is related to precipitation, such as, for example, a rainfall. Rainfall is one relevant climate related variable as it is known to be representative of a climate influence to flooding. For example, summer storms which produce intense rainfall have been found of particular significance in basement flooding. It is contemplated that other climatic events such as excessive snow melt during the spring or winter thaw, river flooding, and storm surges along coastal areas, may have some contribution in basement flooding and could be taken into account by the risk assessor 30. Rainfall is also relevant for the risk assessor 30 because actual values of rainfall are available for each of the geographical areas 35. As will be described below, the risk assessor 30 uses sets of actual values of the climate variable Rₜ to predict the risk of the flooding event to occur in future periods of time. Thus, if for example rainfall data were not available, but temperature data would be, the temperature could be considered to be the climate related variable Rₜ. It is contemplated that more than one climate related variable Rₜ could be used. For example, the plurality of variables 40 could include the rainfall and temperature.

The climate related variable or climate variable Rₜ is related to a rainfall index rₜ as follows:

$${R}_{t} = \frac{{r}_{t}}{{r}_{0}}$$

where r₀ is the rainfall index for a base year, and rₜ is the rainfall index for a future year (i.e. time horizon).

The base year is defined as the average over the period 1980-2009, and the future years are defined as follows: for t=1, the average over the period 2010-2039, for t=2, the average over the period 2040-2069, and for t=3, the average over the period 2070-2099. It is contemplated that the base year and the future years could be defined differently. For example, only one, two or more than three time horizons could be used. In another example, shorter time horizons over 10 or 20 years could be used. It is contemplated that estimation of the rainfall index rₜ for future years may be more or less reliable depending on the length of the time periods considered.

The rainfall index rₜ depends on a rainfall intensity I expressed in mm/hr (i.e. rainfall depth over a one hour period) and a rainfall duration D expressed in min as follows:

$${r}_{t} = {\sum }_{j = 1}^{m} {\sum }_{i = 1}^{n} {P}_{i} {D}_{j} {I}_{ij}$$

where Pᵢ is the probability of rainfall to occur for the return period RPᵢ for a time period i between 1 and n, and j is a duration in min between 1 and m. Rainfall intensities I, rainfall durations D, probabilities Pᵢ and return periods are gathered in an intensity duration and frequency (IDF) table 60. The IDF table 60 is retrievable by the risk assessor 30 from the database 22. FIG. 4 provides an example of the IDF table 60. The IDF table 60 provides current and future rain fall intensities I and durations D. The IDF table 60 features return periods RP and their associated probabilities P (based on extreme value analysis) of a rainfall event under consideration to occur in a given period

$$( P = \frac{1}{RP} ) .$$

The table 60 reads as follows: the second column of table 60 is for a return period RP of 2 years and has a probability of 0.5 (i.e. 50% chance) of the rainfall event under consideration to occur in a given year. Similarly, a 10 year return period RP has a 10% chance and a 100-year return period RP has a 1% chance of the rainfall event under consideration to occur each year. A total volume of rain that has fallen can be deduced from the IDF table 60. Taking the example of a rainfall event in the 10 year return period RP that lasted 5 min, the IDF table 60 indicates an intensity I of 178 mm/hr thus a depth of rainfall of 14.8 mm. In another example, a 24 hours rainfall (i.e. 1440 mins) for the same 10-year return period RP may be corresponds to 96 mm of rainfall, based on the IDF table 60.

In order to determine the base (or current) rainfall index r₀, historical short duration rainfall data for the municipality 33 can be obtained from governmental environmental agencies such as, for example, the Environmental Protection Agency or Environment Canada. It is also contemplated that rainfall data could be obtained from one or more entities other than a governmental environmental agency, or from other local or non-governmental agencies. Environment Canada provides different sets of data providing from a plurality of meteorological stations in the vicinity of the municipality 33. The sets of data include the rainfall intensities I and the durations D recorded during the base period 1980-2009. It is contemplated that additional data could be used. For example, precipitation, maximum temperature, minimum temperature and mean temperature could also be retrieved. Based on the different sets available, an appropriate data set is extracted. The appropriate set is determined so that the data period is of sufficient duration, and the data is coming from the one or more meteorological stations closest to the municipality 33. The sufficient duration is set to be a period of at least 15 years. It is contemplated that the sufficient duration could be more or less than 15 years. For example, depending on the data available, the period of time could be shorter. Based on the above decision criteria, the period 1980-2009 has been chosen to be the baseline of historical values of the municipality 33 for the risk assessor 30. The rainfall intensities I and durations D are then prepared for the selected data set based on extreme value analysis. The Gumbel curve fitting using the method of moments is used. It is contemplated that other methods could be used. The selected data forms thus the baseline historical rainfall r₀.

In order to estimate the intensities I and durations D for future years, predictions made by Global Climate Models (GCMs) (also sometimes referred to as ‘General Circulation Models’) for a given climate change scenario have been downscaled. Downscaling is a method of spatially and temporally increasing the resolution of the climate model predictions. GCMs have a coarse spatial scale (on the order of 100-400 km by 100-400 km) and the climate predictions typically average on a monthly basis. Thus, downscaling allows the GCM predictions to become more relevant at a local scale (i.e. at a scale of the geographical areas 35).

The downscaling model used by the risk assessor 30 is the Long Ashton Research Station Stochastic Weather Generator (LARS-WG) version 5.5 © 1990-2011, Rothamsted Research, U.K., available at: http://www.rothamsted.bbsrc.ac.uk/mas-models/larswg.php, which is incorporated herein by reference. The LARS-WG is a relatively minimally computational intensive algorithm that employs a stochastic weather generator to simulate the daily weather (time series of precipitation and temperature) based on the observed statistical characteristics of the weather at a given local site. It is contemplated that other downscaling methods could be used. For example, the Statistical Downscaling Model (SDSM) version 4.2 available at: https://co-public.lboro.ac.uk/cocwd/SDSM/developed by Drs. Robert Wilby and Christian Dawson, incorporated herein by reference, could be used.

The GCMs are developed by various international climate modeling centers. The risk assessor 30 uses data and predictions from models developed from the following modelling centres: Beijing Climate Center, Bjerknes Centre for Climate, Canadian Centre for Climate Modelling and Analysis (CCCma), Centre National de Recherches Meteorologiques, Australia's Commonwealth Scientific and Industrial Research Organisation (CSIRO), Max Planck Institute for Meteorologie, Meteorological Institute, University of Bonn Meteorological Research Institute of KMA, Geophysical Fluid Dynamics Laboratory (GFDL), NOAA, U.K. Meteorological Office, INGV National Institute of Geophysics and Volcanology Italy, Institute for Numerical Mathematics, Russian Academy of Science, Institut Pierre Simon Laplace, National Institute for Environmental Studies, University of Tokyo, Meteorological Research Institute, Japan Meteorological Agency, and National Center for Atmospheric Research (NCAR). The models simulate future climate based on different socio-economic and technological scenarios that result in different rates of land use changes, population growth, economic growth, and technological change that result in net greenhouse gas emissions into the atmosphere and associated global temperature changes.

The climate scenarios are developed by the World Meteorological Organisation (WMO) and the United Nations Environment Programme (UNEP), and are described in the Intergovernmental Panel on Climate Change (IPCC) special report on emission scenarios ‘IPCC, 2000: Special Report on Emission Scenarios, Nebojsa Nakicenovic and Rob Swart (Eds.), Cambridge University Press, UK. pp 570)’, incorporated herein by reference.

Each of the models recited above provides its own predictions of the climate based on the various climate change scenarios. Each GCM has its own algorithms for predicting the future climate and hence its own biases and uncertainties. Therefore, for a given climate change scenario, each model would give a different prediction of the future climate. For example, for a given location and given climate change scenario, one GCM may predict an increase in rainfall while another may predict less of an increase or even a decrease in rainfall. Also, the timing of such changes may be different from model to model. However, each scenario and prediction has an equal likelihood of occurring and has been considered as equal in occurrence. In order to provide an upper and lower range in the predicted changes in rainfall intensities, the models and predictions that give the greatest and least increase (or decrease, as the case may be) in predicted rainfall in the future relatively to the baseline period of the 1960-1990 have been selected for the risk assessor 30. The climate model described herein is only one example of climate modeling that could be used by the risk assessor 30.

Referring back to FIG. 2, the plurality of observation variables 42 of the risk assessor 30 includes: residential building count RBCOUNT (no unit), industrial building count IBCOUNT (no unit), residential building area RBAREA (meter square divided by 1000), farm parcel count FPCOUNT (no unit), mean terrain slope TSLOPEMEAN o(percent), combined sewer density CSDENSITY (km/ha), average age of combined sewer weighted by length ACSLENGTH (years), and hydrodynamic slope diameter low risk rating HDS 1 (categorical, 0 or 1). As can be appreciated, some of the pluralities of observation variables 42 are related to vulnerability (farm parcel count FPCOUNT, combined sewer density CSDENSITY, average age of combined sewer ACSLENGTH, and hydrodynamic slope diameter low risk rating HDS 1), while others are related to exposure (residential building count RBCOUNT, industrial building count IBCOUNT, and residential building area RBAREA). The plurality of observation variables 42 are variables believed to influence flooding. Taking the example of residential building count RBCOUNT, a higher residential building count RBCOUNT will most likely result in a higher risk of flooding. Although the plurality of observation variables 42 of the risk assessor 30 described herein is related to infrastructure, it is contemplated that some or all of the observation variables 42 could be unrelated to infrastructure. For example, land use, soil type, soil permeability, vegetation cover, slope, tree cover, could be observation variables 42 unrelated to infrastructure, yet related to flooding. It is contemplated that the plurality of variables 42 could contain more or less than the ones described above. It is also contemplated that the plurality of variables 42 would change would the municipality 33 be a different one.

The actual values of the plurality of variables 42 are data given by the municipality 33. It is contemplated that the data could be coming from entities other than the municipality 33. It is also contemplated that some of the data could not be available in some of the geographical areas 35.

The plurality of variables 42 listed above represents a sub-set of all the variables that could influence flooding (positively or negatively). The variables 42 have been preselected as being variables most influencing the flooding. Which variable is considered to be one of the pluralities of variables 42 is also determined depending on actual data available for the geographical areas 35. Even if a variable seems a good candidate, it is most likely not to be retained if there is no actual data to quantify it, since it would not allow the statistical method implemented in the risk assessor 30 to be performed. A method 100′ of assessing a risk of flooding where the plurality of variables 42 is selected from a pool of potential variables using statistical means will be described below.

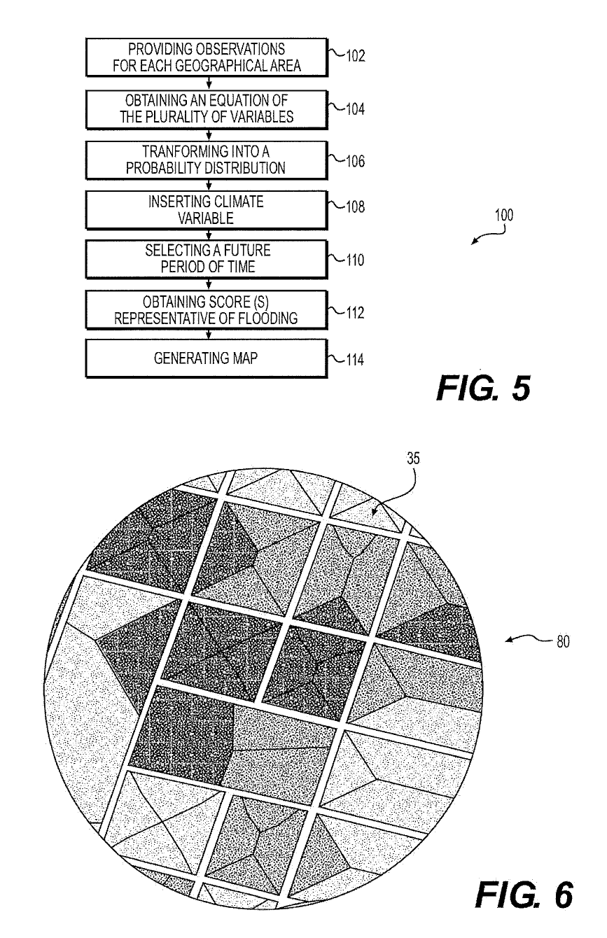

Turning now to FIG. 5, a method 100 of estimating risk of flooding used by the risk assessor 30 will be described.

The method starts at step 102 by providing an observation for each of the geographical areas 35. An observation includes actual values of the variables 42 and their associated known event. The event is due to an occurrence of flooding in the geographical area 35 under consideration. When flooding event has occurred, the event is attributed a scores of 1 (S=1), and when the flooding event has not occurred, the event is attributed a scores of 0 (S=0)). An example of observation in a geographical area 35 recorded for the municipality 33 of Hamilton, Ontario, Canada is: CONSTANT=1, RBCOUNT=4.209, HDS 1=0, RBAREA=0.685, ACSLENGTH=4.508, CSDENSITY=2.929, IBCOUNT=0.932, FPCOUNT=0.084, TSLOPEMEAN=3.101. The plurality of variables 42 is also often referred to as ‘dependent variables’ and the event as the ‘independent variable’. The known observations associated with each of the geographical areas 35 are accessible and retrieved by the risk assessor 30 from the database 22. It is contemplated that each geographical area 35 could have more than one observation. It is also contemplated that some of the observations could be missing values for some of the actual values of the variables 42 or some of the events. It is contemplated that the value associated with the event could be different from 0 and 1.

The event in each observation is known when a flooding event has occurred in the geographical area 35 under consideration. A flooding event is deemed to have occurred when it has been recorded between 2003 and 2009 by an insurance company when a claim is being filed. It is contemplated that the period of time for flooding events consideration could be shorter or longer than 6 years and could be for a period of time other than the one recited above. If more than one flooding event has been recorded in the geographical area 35 under consideration, the flooding event is deemed to have occurred once regardless of the number of claims filed and S=1. It is contemplated however, that the event could be categorized in relationship with a number of claims filed in the geographical area 35 under consideration. For example, if two claims were recorded, the event could be attributed the number 2 whereas if only one claim were recorded, it would be attributed the number 1. It is contemplated that the flooding events could be recorded by entities other than the insurance companies. For example, government agencies could provide information about the occurrence of flooding. In another example, sensors transmitting information in real time could be used to determine the occurrence of flooding. It is contemplated that the data could be provided by two or more sources. It is also contemplated that the known events could not have been at all recorded. For example, a panel of engineers could arbitrarily decide that given a certain set of known variables, the event should have this or that value and the event would be deemed to have occurred. Also, due to the nature of the recordation of the flooding events, it may be that a flooding event may actually have occurred but has not been recorded, and thus will be deemed as not having occurred. While this scenario is possible, it is being taken into account implicitly by the statistical nature of the estimation of the flooding risk.

At step 104, the plurality of observations of the municipality 33 is used to perform a linear regression as part of a discriminant analysis so as to obtain an equation E1 of the plurality of variables 42. Discriminant analysis is a classical statistical tool used to determine an unknown categorical event (here: flooding event) when known observations are provided. Discriminant analysis is described in ‘Multivariate analysis’ by Dillon W., and Goldstein M., John Wiley & Sons, New York, 1984, the entirety of which is incorporated herein by reference.

The discriminant analysis of the risk assessor 30 is a two-group categorical discriminant analysis (flooding event has occurred (S=1) or not (S=0)). It is contemplated however, that a three or more-group categorical discriminant analysis could be used. Three or more-group categorical discriminant analysis is also called Multiple Discriminant Analysis. For example, a Multiple Discriminant Analysis could involve the categorisation of the known event in three groups: high, medium or low flooding strength. It is also contemplated that the known event could be a continuous measure as opposed to a categorical measure. An example of a continuous measure could be the level of damage due to flooding. The level could be measured in terms of depth of flooding or dollar amount spent for repairs. Although the variables 42 are measurable. It is contemplated however, that some or all of the variables 42 could be categorical.

The linear regression is based on the Ordinary Least Squares. The result of the linear regression is a plurality of weights cᵢ (i=0 . . . 9 where q is the number of variables 42 plus 1) linking the variables 42 to a quantification z of the event into an equation E1.

z=c₀+c₁*RBCOUNT+c₂*RBAREA+c₃*IBCOUNT+c₄*FPCOUNT+c₅*TSLOPEMEAN+c₆*CSDENSITY+c₇*ACSLENGTH+c₈*HDS1 (E1)

The weights cᵢ represent the relative relationships between the variables 42. As can be appreciated, one can obtain an estimate of an unknown event by plugging a set of known values of the plurality of variables 42 in the equation E1. It is contemplated, however, that a linear regression using tools other than the Ordinary Least Squares could be used. It is also contemplated that a non-linear regression or a non parametric regression could be performed. It is contemplated that where the event has more than two categories, there would be more than one equation linking the variables 42. It is also contemplated that some of the equations could only link some of the variables 42 to each other, such as in Seemingly Unrelated Regression. It is also contemplated that then would be more or less weights cᵢ depending on the number of variables 42.

At step 106, the equation E1 is transformed into a probability distribution E2. A log odd equation based on a normal distribution is used to transform the equation E1 into the probability distribution E2.

$$p = \frac{{e}^{{a}_{1} + {a}_{2} * ln ( w )}}{1 + {e}^{{a}_{1} + {a}_{2} * ln ( w )}} , where w = \frac{z + {b}_{1}}{{b}_{2}} \\ if z < - {b}_{1} , then p = 0 \\ if z > {b}_{2} - {b}_{1} , then p = 1 \qquad ( E 2 )$$

The coefficients a₁, a₂, b₁, b₂ are determined so that the probability P has finite boundaries. For example, if the linear regression outputs: c₀=0.073, cᵢ=0.153, c₂=−0.499, c₃=−0.02, c₄=−0.112, c₅=−0.026, c₆=0.053, c₇=−0.008, c₈=−0.884 then a₁=12.7327,a₂=11.67067, b₁=6.54, b₂=24.89, such that equation E2 becomes:

$$p = \frac{{e}^{12.7327 + 11.67067 * ln ( w )}}{1 + {e}^{12.7327 + 11.67067 * ln ( w )}} , where w = \frac{z + 6.54}{24.89}$$

$$if z < - 6.54 , then p = 0$$

$$if z > 18.35 , then p = 1.$$

The probability distribution E2 helps visualising the event but also to introduce the climate variable Rₜ (as will be described below). It is contemplated that equations other than the log odd could be used to transform the equation E1 into the probability distribution E2. For example, an empirical distribution or a Poisson distribution could be used. It is also contemplated that the equation E1 could be transformed into an equation that would not be probabilistic. It also contemplated that step 106 could be omitted. For example, z could be directly used to estimate the event. A threshold zₜ could be used to categorize z into one of the categories of the event. If z>zₜ, then S=1, i.e. a flooding event has occurred for the set of known values of the plurality of variables 42 inputted in the equation E1. Similarly, if z<zₜ, then S=0, i.e. a flooding event has not occurred for the set of known values of the plurality of variables 42 inputted in the equation E1. It is also contemplated that more than one threshold could be used, such that z could be categorized into three or more categories. Such categories could be ‘high’, ‘medium’, and ‘low’ risks of the flooding event to occur.

At step 108, the climate variable Rₜ is inserted into the probability distribution E2 to form a score function E3.

$${p}_{t} = \frac{{e}^{{a}_{1} * {R}_{t} + {a}_{2} * ln ( w )}}{1 + {e}^{{a}_{1} * {R}_{t} + {a}_{2} * ln ( w )}} , where w = \frac{z + {b}_{1}}{{b}_{2}} \\ if z < - {b}_{1} , then p = 0 \\ if z > {b}_{2} - {b}_{1} , then p = 1 \qquad ( E 3 )$$

The score function E3 provides an estimate of the risk of flooding for a future period of time (i.e. for a period of time posterior to the observations). It is contemplated that the climate variable Rₜ could be introduced differently in the equation E3. It is also contemplated that step 108 could be omitted and that the climate variable Rₜ could be introduced as one of the variables 42 and be linked to the event by the linear regression at step 102. In order to allow for future predictions, the equation E2 could be modified so that one or more of the plurality of variables 42 would express a change in time such as increase of building density in time, or decrease in pipe diameter as it ages. It is also contemplated that the risk assessor 30 could use both a change in climate and a change in infrastructure for climate modeling.

At step 110, a future period of time for which the risk of the flooding event to occur is to be estimated is inputted by the user 17. The future years are selected from the group t=1 for the average over the period 2010-2039, t=2 for the average over the period 2040-2069, t=3 for average over the period 2070-2099, that was defined for the determination of the rainfall index rₜ. It is contemplated that the user 17 could use the risk assessor 30 for different future periods of time given all other variables being identical. In that case, the score functions E3 for the geographical areas 35 could be stored in the database 22 and the user 17 would go perform step 114 for each geographical area 35 and perform step 116 at the end.

At step 114, the probability pₜ is calculated for the future period of time selected by the user 17 in each geographical area 35 using the values of the variables 42 of the observation in that geographical area 35. It is contemplated, however, that a set of values of the variables 42 not used in the linear regression could be used. For example, a new set of values for the variables 42 that would incorporate change of the variables 42 in time could be used. The values would represent an estimation of the value of the variables at the future period of time selected by the user 17.

The probability pₜ is then compared to two predetermined thresholds Pₜ_{_{—}}_{high}, Pₜ_{_{—}}_{low} representative of separations between a high likelihood of a flooding event to occur and a low likelihood of a flooding event to occur. By comparing the probability p, the score S is attributed to each geographical area 35 where the probability P was obtained. The event of the risk assessor 30 is categorized in three categories: ‘high’, ‘medium’ and ‘low’. Thus, if p>pₜ_{_{—}}_{high}, then the flooding event is likely to occur and S=1, ‘high’. If pₜ_{_{—}}_{low}<p<pₜ_{_{—}}_{high}, then the flooding event is probable to occur and S=0.5, ‘medium’. If p<pₜ_{_{—}}_{low}, then the flooding event is not likely to occur and S=0, ‘low’. It is contemplated that the event could be categorized in only two or more than three categories, and the score S can be associated with values other than 0, 1, and 0.5.

At step 114, the computer 10 displays a map 80, shown in FIG. 6, where shadings are associated with the scores S in each geographical area 35. Dark shading is displayed when a ‘high’ risk of flooding has been estimated for the geographical area 35 under consideration and S=1. Medium shading is displayed when a ‘medium’ risk of flooding has been estimated for the geographical area 35 under consideration and S=0.5. Light shading is displayed when a ‘low’ risk of flooding has been estimated for the geographical area 35 under consideration and S=0. It is contemplated that the map 80 could display colors instead of the shadings recited above. For example, red, yellow and green could be used to represent respectively, high, medium and low risks of flooding. It is also contemplated that the map 80 could display numbers instead of colors. For example, the map 80 could be replaced by a table displayed by the computer 10, or any other way to display information related to the probability pₜ, and the flooding event. It is contemplated that only some of the categories could be displayed. For example, the user 17 could choose to display only the ‘high’ category, or only the ‘high’ and ‘medium’ categories. It is contemplated that the user 17 could choose between different interfaces for displaying the outputted results of the risk assessor 30.

It is contemplated that additional steps could be performed based on the probability pₜ. For example, where the probability pₜ is high, the user 17 could alert the municipality 33's council that some infrastructure component needs to be changed. For example pipes would need to be replaced, or constructions would need to be redone.

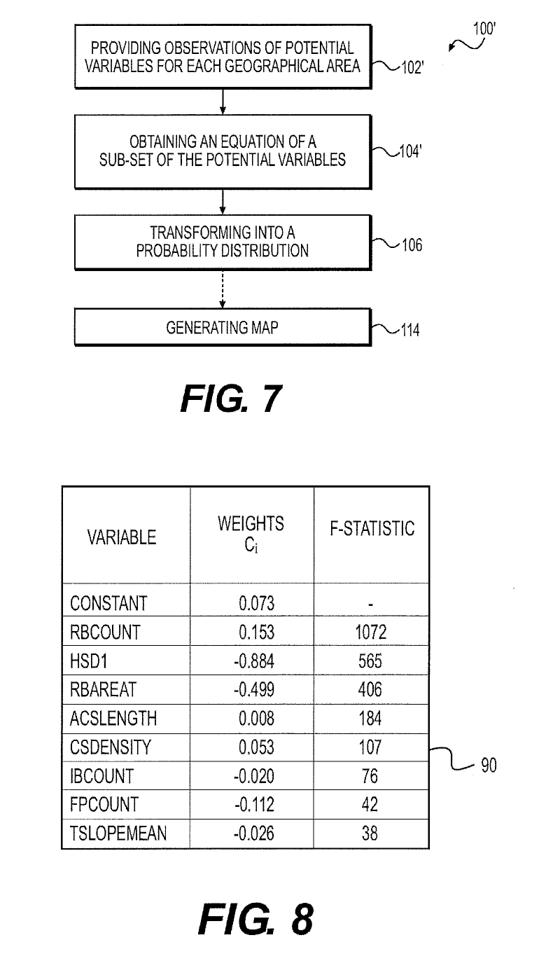

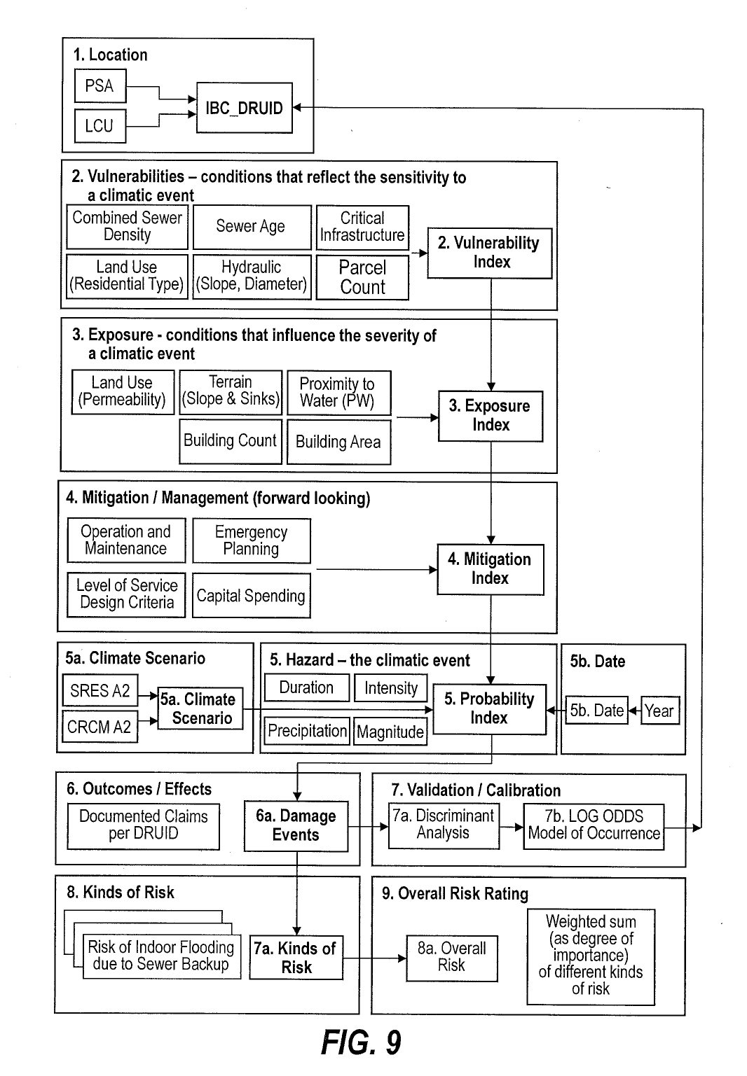

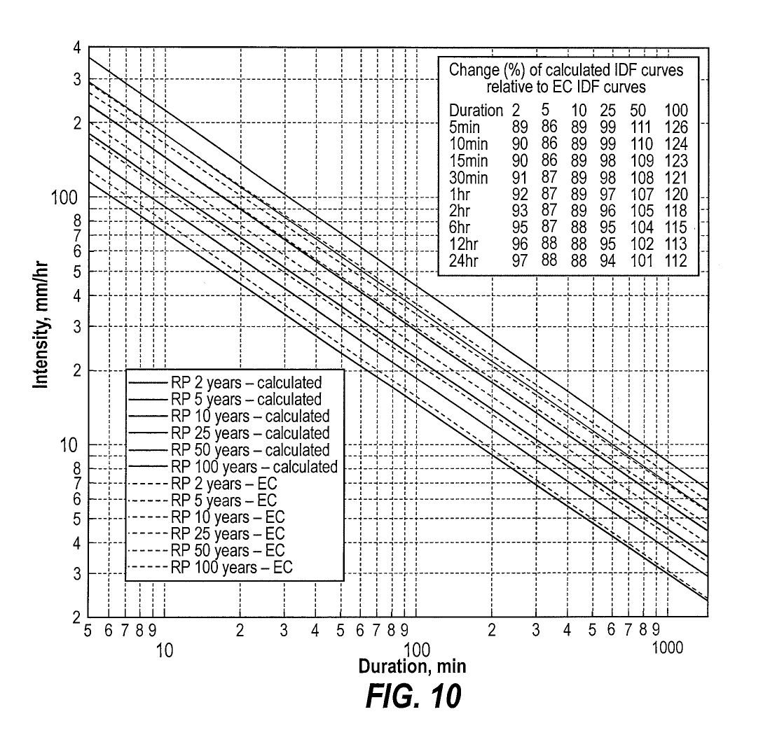

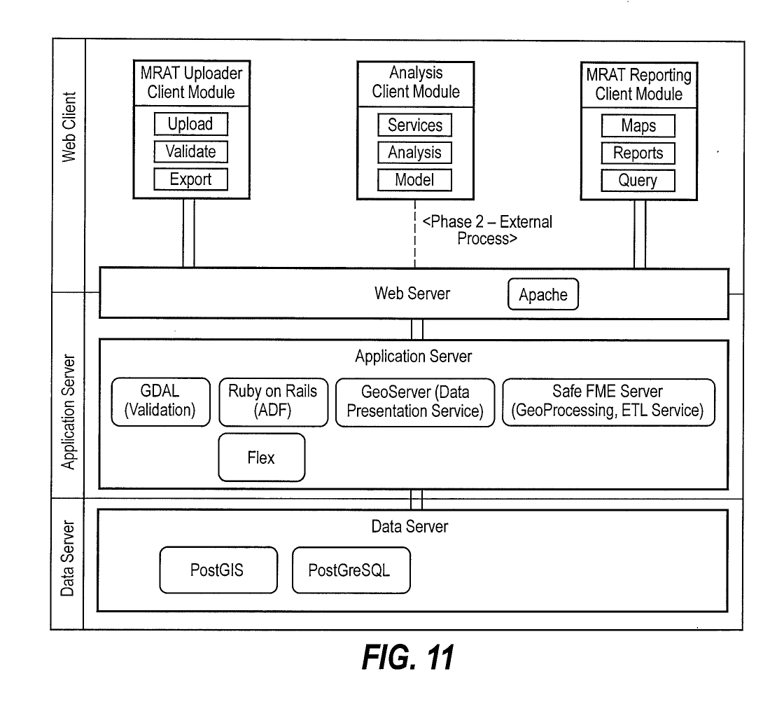

Turning now to FIGS. 7 and 8, a method 100′ of assessing a risk of flooding where the plurality of variables is selected from a pool of potential variables will now be described. The method 100′ has steps common with the method 100 which will not be described in great detail herein again.

Referring to FIG. 7, the method 100′ starts with step 102′ by providing a known observation for each of the geographical areas 35, where each known observation contains a plurality of potential variables. The plurality of potential variables is common to the geographical areas 35. Criteria for selecting the potential variable are similar to the ones recited above for the variables 42, and are based on relevance to flooding and availability of actual data in the geographical areas 35.

At step 104′, a sub-set of the potential variables is determined and is linked to the flooding event by a linear regression equation similar to equation E1. As described above, the sub-set of the potential variables is a sub-set where variables most representative of their relationship with flooding are determined using statistical means. The selection of the sub-set of variables and the linking with the flooding event is done simultaneously using a Backward Stepwise Discriminant Analysis. The Backward Stepwise Discriminant Analysis is a classical statistical tool, which is described in ‘Multivariate analysis’ by Dillon W., and Goldstein M., John Wiley & Sons, New York, 1984, the entirety of which is incorporated by reference. It is contemplated that Stepwise or Forward Discriminant Analysis could be used instead of the Backward Stepwise Discriminant Analysis. It is also contemplated that methods like log odds modeling could also be used.

The statistical decision of selecting a variable from the set of potential variables is made with the help of several measurement tools. Analysis of covariance (ANCOVA) is performed with the help of a partial F-statistics (also sometimes called Fisher statistics). ANCOVA is a known statistical tool and is described in ‘Multivariate analysis’ by Dillon W., and Goldstein M., John Wiley & Sons, New York, 1984, the entirety of which is incorporated herein by reference. ANCOVA treats the dependent variables as the categories (or groups) and the flooding event as a dependent variable. It is contemplated that Multiple Analysis of covariance (MANCOVA) would be used if the categorization of the flooding event involved more than two groups. It is also contemplated that Analysis of Variance (ANOVA) (and Multiple Analysis of Variance (MANOVA) where the case may be) could be used in addition to or instead of the ANCOVA.

The criterion for entry and removal of an independent variable uses the F-statistics. The F-statistics is described in ‘Multivariate analysis’ by Dillon W., and Goldstein M., John Wiley & Sons, New York, 1984, the entirety of which is incorporated by reference. The F-statistics gives the relative importance of the independent variables. Because each of the potential variables have a different unit and/or scale, comparing a magnitude of the weights of the linear regression of the potential variables may not give direct information about which variable selected to be part of the sub-set is more important in terms of its influence on flooding than another. The F-statistics is a number associated with each of the selected sub-set variables that constitutes an indicator of a relative importance of the selected sub-set variables. An example of F-statistics and weights cᵢ is provided in table 90 in FIG. 8. The table 90 shows that the residential building count RBCOUNT has an associated F-statistics of 1072, whereas the residential building area RBAREA has an associated F-statistics of 406, which indicates that residential building count RBCOUNT would contribute more to flooding than residential building area RBAREA. Furthermore, a sign of the weights cᵢ indicates a positive or negative influence of the associated variable from the sub-set of variables. Still referring to table 90, the weight cᵢ of the residential building count RBCOUNT is positive, which means that an increase of residential building count RECOUNT would increase the likelihood of flooding, whereas the weight cᵢ of the mean terrain slope TSLOPEMEAN is negative, which means that an increase of mean terrain slope TSLOPEMEAN would decrease the likelihood of flooding. It is contemplated that the F-statistics could be used by the person skilled in the art to determine if the selected variables 42 are physically realistic. It is contemplated that instead of the F-statistics, Maximum Likelihood techniques and measures such as the Akaike's Information Criterion (AIC) could be used. It is also contemplated that tools additional to the F-statistics could be used. For example, Z-score weights, group means, classification functions, and contingency tables could be used.

A geographic information system (GIS) risk map can be generated for a municipality, and a working section of the section can be provided which will allow municipalities to see the impact of certain infrastructure projects on the water damage risk score in any given geographic area.

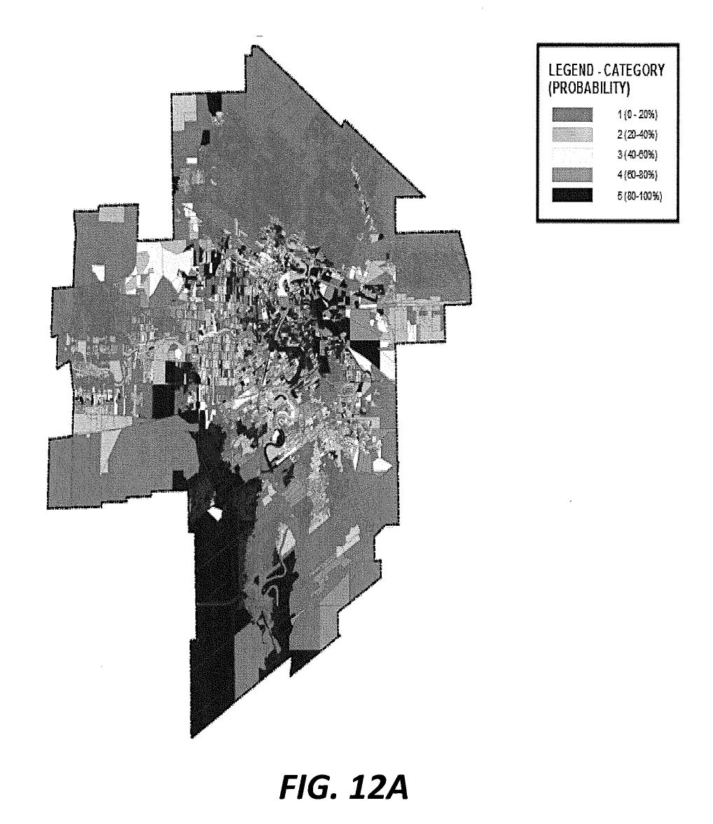

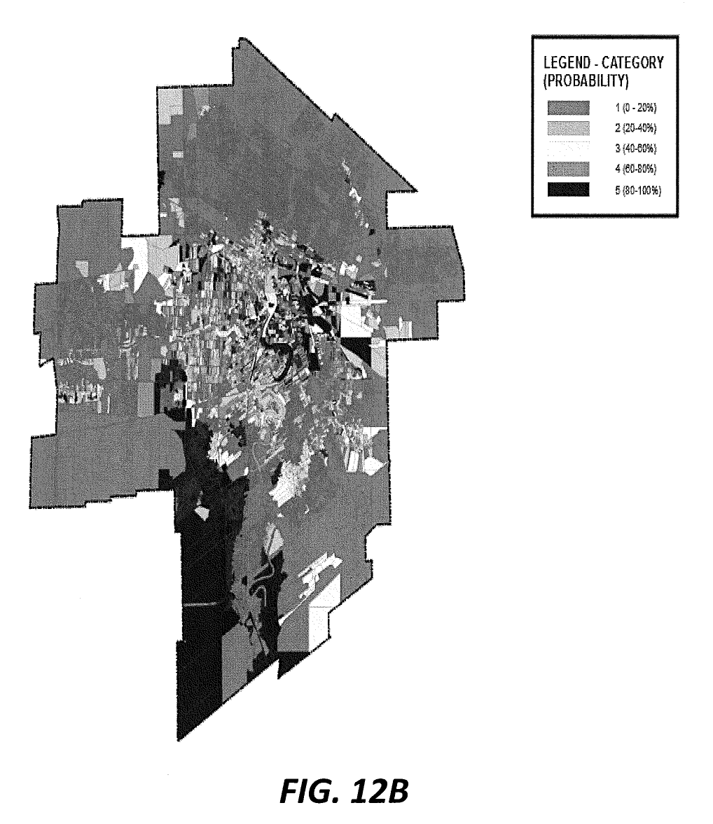

FIGS. 12A and 12B show geographical maps of a predicted water damage risk for a plurality of geographical areas in a municipality for a low rain scenario (12A) and a high rain scenario (12B). Within a municipality, risk indicators can be combined with present and future climate return periods, and represent risk zones on a geographic information system map. In effect, this map would be a visual representation of water damage risk zones within the municipality, based on climatic parameters calibrated using the backflow threshold and return periods. The “risk zones” in respect of which risk determinations can be made, referred to as “Distinctive Risk Unit Indicators” (DRUIDs). The geographical areas can vary in size depending on local conditions but may be as small as the area occupied by 10 homes. The risk score can be expressed as a percentage likelihood (within a range of, for example 10%-20% or 40%-50%) of a risk of a water damage event occurring within a certain timeframe, shown on the maps as variations in greyscale.

Modifications and improvements to the above-described embodiments of the present invention may become apparent to those skilled in the art. The foregoing description is intended to be exemplary rather than limiting. The scope of the present invention is therefore intended to be limited solely by the scope of the appended claims.

What is claimed is:

1. A method of estimating risk of a future water damage event in at least one geographical area, the method comprising:
selecting at least one observation variable, the at least one observation variable having at least one set of values recorded for the at least one geographical area over a period of time that includes a past water damage event, the at least one observation variable influencing flooding in the at least one geographical area;
selecting at least one climate variable, the at least one climate variable having at least one value for the at least one geographical area, the at least one climate variable influencing the water damage event in the at least one geographical area; and
determining for the at least one geographical area a flood risk score representative of the risk of the future water damage event to occur based on the at least one observation variable and the at least one climate variable.

2. The method of claim 1, wherein the method is carried out in a plurality of geographical areas in a municipality.

3. The method of claim 1, wherein the at least one observation variable is selected from a combined sewer density, an average age of a combined sewer, a hydrodynamic slope, a building count, a building area, a land use, a soil type, a soil permeability, a vegetation cover, a slope, and a tree cover terrain slope.

4. The method of claim 1, wherein more than one observation variable is selected.

5. The method of claim 1, wherein the at least one climate variable is obtained from an intensity, duration and frequency of precipitation in the at least one geographical area.

6. The method of claim 1, wherein determining the flood risk score comprises:
determining a function of the at least one observation variable;
transforming the function into a probability distribution;
transforming the probability distribution into a score function wherein the score function depends on the at least one climate variable; and
determining the flood risk score by inputting into the score function at least one value of the at least one observation variable and at least one value of the at least one climate variable.

7. The method of claim 6, wherein transforming the function into a probability distribution includes using a log odd function.

8. The method of claim 1, wherein the water damage event is a categorical event, and wherein determining the flood risk score further comprises:
performing at least one of a forward discriminant analysis, a backward discriminant analysis and a stepwise discriminant analysis.

9. The method of claim 7, wherein determining the flood risk score further comprises:
comparing the probability distribution of the at least one geographical area to at least one predetermined probability threshold.

10. The method of claim 1, further comprising displaying the flood risk score associated with the at least one geographical area on a map.

11. A method of mitigating a future water damage event in at least one geographical area, the method comprising:
selecting at least one observation variable, the at least one observation variable having at least one set of values recorded for the at least one geographical area over a period of time that includes a past water damage event, the at least one observation variable influencing water damage in the at least one geographical area;
selecting at least one climate variable, the at least one climate variable having at least one value for the at least one geographical area, the at least one climate variable influencing water damage in the at least one geographical area;
determining for the at least one geographical area a flood risk score representative of the risk of a future water damage event to occur based on the at least one observation variable and the at least one climate variable; and
indicating at least one infrastructure component in the at least one geographical area to be at least repaired to reduce the flood risk score in the at least one geographical area.

12. The method of claim 11, wherein the method is carried out in a plurality of geographical areas in a municipality.

13. The method of claim 11, wherein the at least one infrastructure component is a sewer system.

14. The method of claim 11, wherein the at least one observation variable is selected from a combined sewer density, an average age of a combined sewer, a hydrodynamic slope, a building count, a building area, a land use, a soil type, a soil permeability, a vegetation cover, a slope, and a tree cover terrain slope.

15. The method of claim 11, wherein more than one observation variable is selected.

16. The method of claim 11, wherein the at least one climate variable is obtained from an intensity, duration and frequency of precipitation in the at least one geographical area.

17. The method of claim 11, wherein determining the flood risk score comprises:
determining a function of the at least one observation variable;
transforming the function into a probability distribution;
transforming the probability distribution into a score function wherein the score function depends on the at least one climate variable; and
determining the flood risk score by inputting into the score function at least one value of the at least one observation variable and at least one value of the at least one climate variable.

18. The method of claim 17, wherein transforming the function into a probability distribution includes using a log odd function.

19. The method of claim 11, wherein the future water damage event is a categorical event, and wherein determining the flood risk score further comprises:
performing at least one of a forward discriminant analysis, a backward discriminant analysis and a stepwise discriminant analysis.

20. The method of claim 19, wherein determining the flood risk score further comprises:
comparing the probability distribution of the geographical area to at least one predetermined probability threshold.

21. The method of claim 11, further comprising displaying the flood risk score associated with the at least one geographical area on a map.

22. A computer-implemented system for estimating or mitigating a future water damage event in at least one geographical area, the system comprising:
a database; and
a computer processor in electronic communication with the database, the computer processor in electronic communication with a software program, the software program including instructions that when executed by the computer processor:
selects at least one observation variable, the at least one observation variable having at least one set of values recorded for the at least one geographical area over a period of time that includes a past water damage event, the at least one observation variable influencing flooding in the at least one geographical area;
selects from the database at least one climate variable, the at least one climate variable having at least one value for the geographical area, the at least one climate variable influencing flooding in the at least one geographical area; and
determines for the at least one geographical area a flood risk score representative of the risk of a future water damage event to occur based on the at least one observation variable and the at least one climate variable.

23. The system of claim 22, wherein the software program further includes instructions that when executed by the computer processor:
indicates at least one infrastructure component in the at least one of the plurality of geographical area to be at least repaired to reduce the flood risk in the at least one geographical area.

24. The system of claim 22, wherein the method is carried out in a plurality of geographical areas in a municipality.

25. The system of claim 22, wherein the at least one observation variable is selected from a combined sewer density, an average age of a combined sewer, hydrodynamic slope, building count, building area, land use, soil type, soil permeability, vegetation cover, slope, and tree cover terrain slope.

26. The system of claim 22, wherein more than one observation variable is selected.

27. The system of claim 22, wherein the at least one climate variable is precipitation.

28. The system of claim 22, wherein determining the flood risk score comprises:
determining a function of the at least one observation variable;
transforming the function into a probability distribution;
determining the probability distribution into a score function wherein the score function depends on the at least one climate variable; and
determining the flood risk score by inputting into the score function at least one value of the at least one observation variable and at least one value of the at least one climate variable.

29. The system of claim 28, wherein transforming the function into a probability distribution includes using a log odd function.

30. The system of claim 22, wherein the water damage event is a categorical event, and wherein determining the flood risk score further comprises:
performing at least one of a forward discriminant analysis, a backward discriminant analysis and a stepwise discriminant analysis.

31. The system of claim 29, wherein determining the flood risk score further comprises:
comparing the probability distribution of the geographical area to at least one predetermined probability threshold.

32. The system of claim 22, further comprising displaying the flood risk score associated with the at least one geographical area on a map.

33. The system of claim 22, wherein the electronic communication between the database and the computer processor is carried out over internet, intranet, or cloud computing.
